(19) United States
(12) Patent Application Publication
(10) Pub. No.: US 2014/0176099 A1
(43) Pub. Date: Jun. 26, 2014

(54) VOLTAGE SUPPLY DEVICE

(71) Applicant: SAMSUNG ELECTRO-MECHANICS CO., LTD., Suwon (KR)

(72) Inventor: Soo Woong LEE, Gyunggi-do (KR)

(73) Assignee: SAMSUNG ELECTRO-MECHANICS CO., LTD., Suwon (KR)

(21) Appl. No.: 13/784,331

(22) Filed: Mar. 4, 2013

(30) Foreign Application Priority Data
Dec. 21, 2012 (KR) 10-2012-0151466

(51) Int. Cl. G05F 1/10

(52) U.S. Cl. CPC G05F 1/10
USPC 323/281

(57) ABSTRACT

There is provided a voltage supply device, including an inputting unit obtaining a reference voltage; an operational amplifier obtaining switching information based on the reference voltage and a feedback voltage, a switching unit outputting an input voltage as the feedback voltage based on the switching information from the operational amplifier, a controlling unit obtaining a control signal based on the reference voltage, and an outputting unit outputting an output voltage and hysteresis information based on the control signal.

### CROSS-REFERENCE TO RELATED APPLICATIONS

This application claims the priority of Korean Patent Application No 10-2012-0151466 filed on Dec. 21, 2012, in the Korean Intellectual Property Office, the disclosure of which is incorporated herein by reference.

### BACKGROUND OF THE INVENTION

1. Field of the Invention

The present invention relates to a voltage supply device capable of adjusting a hysteresis range.

2. Description of the Related Art

A method of generating a common mode voltage in a general system is performed by bandgap reference (BGR). In the case in which BGR is used, a stable common mode voltage may be output.

However, in a case in which the common mode voltage is changed at a predetermined ratio, the common mode voltage cannot be output using the BGR.

Further, in order to improve noise immunity characteristics, hysteresis is used, where the hysteresis needs to be converted to have an appropriate value, according to a power source.

The Related Art Document below relates to a regulator embedded semiconductor device for varying output voltage but does not disclose a method of outputting a common mode voltage and hysteresis information varied at a predetermined ratio according to variable voltage.

### RELATED ART DOCUMENT

Japanese Patent Laid-Open Publication No. 2000-066744

### SUMMARY OF THE INVENTION

An aspect of the present invention provides a voltage supply device capable of outputting an output voltage varying at a predetermined ratio according to a change of reference voltage.

Another aspect of the present invention provides a voltage supply device capable of adjusting a hysteresis range of an output voltage according to a reference voltage.

According to an aspect of the present invention, there is provided a voltage supply device, including: an inputting unit obtaining a reference voltage; an operational amplifier obtaining switching information based on the reference voltage and a feedback voltage; a switching unit outputting an input voltage as the feedback voltage based on the switching information from the operational amplifier; a controlling unit obtaining a control signal based on the reference voltage; and an outputting unit outputting an output voltage and hysteresis information based on the control signal.

The controlling unit may include a plurality of comparators comparing the reference voltage with a reference value.

The controlling unit may include at least one of a peak detector and an analog to digital converter.

The control signal may include hysteresis control bits.

The outputting unit may include a first hysteresis adjusting unit, a first voltage-dividing unit, a second voltage-dividing unit, and a second hysteresis adjusting unit connected to one another in series.

The outputting unit may include a hysteresis adjusting unit adjusting a hysteresis range.

The hysteresis adjusting unit may adjust a resistance value based on the control signal.

The hysteresis adjusting unit may include at least one variable resistor element.

The hysteresis adjusting unit may include resistor elements and switch elements connected to one another in series, and may control the switch elements based on the control signal.

The operational amplifier may be a rail to rail type amplifier.

According to another aspect of the present invention, there is provided a voltage supply device, including: an inputting unit obtaining a reference voltage; a controlling unit obtaining a control signal based on the reference voltage; and an outputting unit obtaining output voltage and hysteresis information based on the control signal.

The controlling unit may include a plurality of comparators comparing the reference voltage with a reference value.

The controlling unit may include at least one of a peak detector and an analog to digital converter.

The control signal may include hysteresis control bits.

The outputting unit may include a hysteresis adjusting unit adjusting the hysteresis information.

The hysteresis adjusting unit may adjust a resistance value based on the control signal.

The hysteresis adjusting unit may include at least one variable resistor element.

The hysteresis adjusting unit may include resistor elements and switch elements connected to one another in series, and controls the switch elements based on the control signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a voltage supply device according to an embodiment of the present invention;

FIG. 2 is a view showing an example of a controlling unit;

FIGS. 3A and 3B are views showing an example of a hysteresis adjusting unit; and

FIG. 4 is a view showing a voltage supply device according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

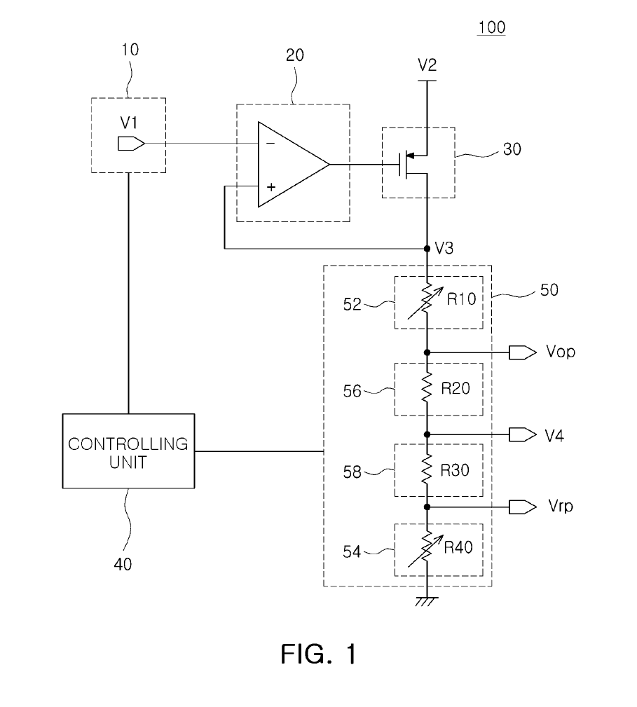

FIG. 1 is a view showing a voltage supply device according to an embodiment of the present invention.

Referring to FIG. 1, the voltage supply device 100 may include an inputting unit 10, an operational amplifier 20, a switching unit 30, a controlling unit 40, and an outputting unit 50.

The inputting unit 10 may obtain a reference voltage V1. The reference voltage V1 may be varied. The inputting unit may be connected to one terminal of the operational amplifier 20.

The switching unit 30 may output an input voltage V2 as a feedback voltage V3. For example, the switching unit 30 may be implemented by a PMOS transistor. In this case, the PMOS transistor may have a source connected to the input voltage V2, a gate connected to the operational amplifier 20, and a drain connected to the outputting unit 50. A type of the switching unit 30 is not limited, and various types of switch devices may be used therefor.

The operational amplifier 20 may obtain switching information based on the reference voltage V1 and the feedback voltage V3. For example, the operational amplifier 20 may compare the reference voltage V1 with the feedback voltage V3 and may output the compared result to the switching unit 30.

Meanwhile, the operational amplifier 20 may be a rail to rail type amplifier.

Meanwhile, the switching unit 30 may be switched according to the switching information. In addition, the switching unit 30 may output the input voltage V2 as the feedback voltage V3 based on the switching information.

The controlling unit 40 may obtain a control signal based on the reference voltage.

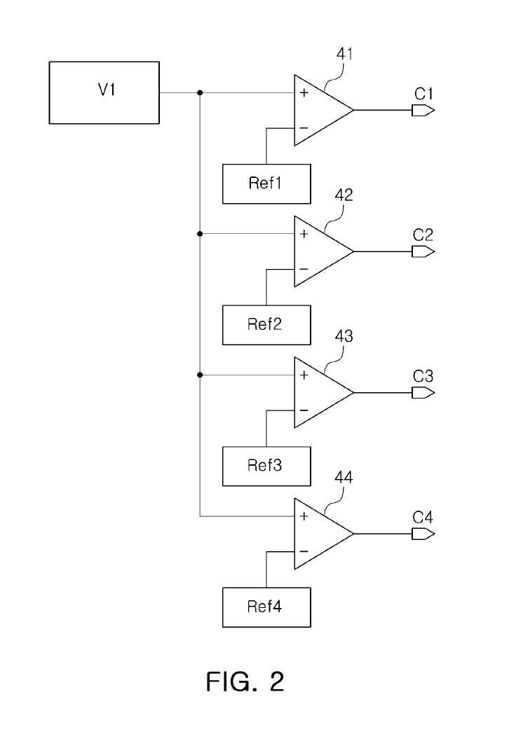

An operation of the controlling unit 40 will be described in detail with reference to FIG. 2.

The outputting unit 50 may output an output voltage V4 and hysteresis information Vop and Vrp, based on the control signal.

According to the embodiment of the present invention, the outputting unit 50 may include a hysteresis adjusting unit and a voltage-dividing unit.

The hysteresis adjusting unit may include a first adjusting unit 52 and a second adjusting unit 54. The hysteresis adjusting unit may adjust the hysteresis information Vop and Vrp. In addition, the hysteresis adjusting unit may be formed by variable resistor elements R10 and R40.

The voltage-dividing unit may include a first voltage-dividing unit 56 and a second voltage-dividing unit 58. In addition, the voltage-dividing unit may be formed by resistor elements R20 and R30.

Referring to FIG. 1, the first adjusting unit 52, the first voltage-dividing unit 56, the second voltage-dividing unit 58, and the second adjusting unit 54 may be connected to one another in series.

According to the embodiment of the present invention, the reference voltage V1 may be applied to the outputting unit 50 by operations of the operational amplifier 20 and the switching unit 30.

Meanwhile, the output voltage V4 may be determined by the first adjusting unit 52, the second adjusting unit 54, the first voltage-dividing unit 56, and the second voltage-dividing unit 58. In addition, the hysteresis information may be determined by the first adjusting unit 52, the second adjusting unit 54, a first voltage-dividing unit 56, and the second voltage-dividing unit 58.

In addition, the voltage across a connection terminal between the first adjusting unit 52 and the first voltage-dividing unit 56 may be defined as first hysteresis information Vop.

In addition, the voltage across a connection terminal between the second voltage-dividing unit 58 and the second adjusting unit 54 may be defined as second hysteresis information Vrp.

In addition, the voltage across a connection terminal between the first voltage-dividing unit 56 and the second voltage-dividing unit 58 may be defined as output voltage.

For example, in the case in which the summation of resistance values of the first adjusting unit 52 and the first voltage-dividing unit 56 is equal to the summation of resistance values of the second adjusting unit 54 and the second voltage-dividing unit 58, the output voltage may become V½. Further, according to the embodiment of the present invention, the resistance value of the first adjusting unit 52 and the resistance value of the second adjusting unit 54 may be equal to each other. In addition, the resistance values of the first voltage-dividing unit 56 and the second voltage-dividing unit 58 may be equal to each other.

That is, according to the above-mentioned method, the output voltage may be generated in proportion to a change in the reference voltage, and a value of the output voltage may be accurately adjusted.

The hysteresis is used in order to allow for a design which is more robust against noise, and in the case in which the input signal or the nose is relatively high, the hysteresis range may be increased. In addition, in the case in which the input signal or the noise is relatively low, the hysteresis range may be decreased.

FIG. 2 is a view showing an example of a controlling unit.

In order to adjust the hysteresis range, the controlling unit 40 may obtain a control signal based on the reference voltage. For example, the control signal may be a hysteresis control bit.

According to the embodiment of the present invention, each of the hysteresis adjusting units may include a plurality of switch elements connected to one another in parallel and resistor elements connected to respective switch elements in series. In addition, the controlling unit 40 may generate a control bit for each switch element included in the hysteresis adjusting unit. The control bit is commonly called a hysteresis control bit.

In addition, the controlling unit 40 may include a plurality of comparators receiving the reference voltage and a predetermined reference value to output the hysteresis control bit.

Meanwhile, the controlling unit 40 may include a peak detector or an analog-digital converter (ADC). In the case in which the reference voltage is an alternating current voltage, the peak detector or the ADC may convert the alternating current voltage into a specific value.

In the present embodiment, a case in which each of the hysteresis adjusting units 52 and 54 includes four switch elements and resistor elements connected to respective switch elements in series is illustrated; however, the present invention is not limited thereto. In addition, a case in which the controlling unit 40 generates a hysteresis control bit for the respective hysteresis adjusting units 52 and 54 is illustrated; however, the present invention is not limited thereto.

Referring to FIG. 2, the controlling unit 40 may include a first comparator 41, a second comparator 42, a third comparator 43, and a fourth comparator 44.

One input terminal of the first comparator 41 may receive the reference voltage. The other input terminal of the first comparator 41 may receive a first reference value Ref1. In the case in which the reference voltage is higher than the first reference value, the first comparator 41 may output a hysteresis control bit C1 as one. In addition, in the case in which the reference voltage is lower than the first reference value, the first comparator 41 may output the hysteresis control bit C1 as zero.

The hysteresis control bit C1 output from the first comparator 41 may control a switching of one switch included in the hysteresis adjusting unit.

One input terminal of the second comparator 42 may receive the reference voltage. In addition, the other input terminal of the second comparator 42 may receive a second reference value Ref2. In the case in which the reference voltage is higher than the second reference value, the second comparator 42 may output a hysteresis control bit C2 as one. In addition, in the case in which the reference voltage is lower than the second reference value, the second comparator 42 may output the hysteresis control bit C2 as zero.

The hysteresis control bit C2 output from the second comparator 42 may control a switching of one switch included in the hysteresis adjusting unit.

Since the third comparator 43 and the fourth comparator 44 may also be operated so as to be the same as the first comparator 41 or the second comparator 42, a detailed description thereof will be omitted.

Meanwhile, an output example of the hysteresis control bit will be described on the assumption that a level of the reference voltage is 0V to 5V, the first reference value is 1V, the second reference value is 2V, a third reference value is 3 v, and a fourth reference value is 4V.

Table 1 shows the hysteresis control bits according to the level of the reference voltage.

TABLE 1

| | Reference | | | | |
|---|---|---|---|---|---|
| No. | Voltage | C1 | C2 | C3 | C4 |
| 1 | 1 V or less | 0 | 0 | 0 | 0 |
| 2 | 1 V~2 V | 1 | 0 | 0 | 0 |
| 3 | 2 V~3 V | 1 | 1 | 0 | 0 |
| 4 | 3 V~4 V | 1 | 1 | 1 | 0 |
| 5 | Above 4 V | 1 | 1 | 1 | 1 |

Here, the switch element of the hysteresis adjusting unit may be switched by the hysteresis control bit including C1, C2, C3, and C4.

The controlling unit 40 may output a plurality of hysteresis control bits according to the level of the reference voltage. Here, the controlling unit 40 may output five hysteresis control bits (No. 1, No. 2, No. 3, No. 4, and No. 5) according to the level of the reference voltage. In addition, at least one switch element in the hysteresis adjusting unit may be switched by the hysteresis control bit.

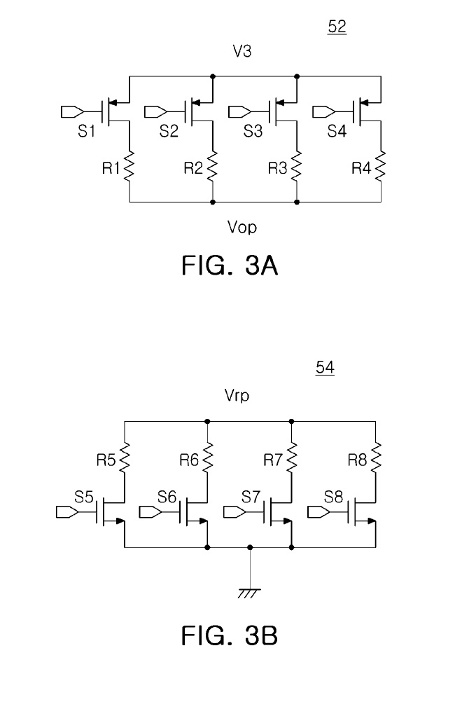

FIGS. 3A and 3B are views showing an example of a hysteresis adjusting unit.

FIG. 3A is a view showing an example of the first hysteresis adjusting unit 52.

FIG. 3B is a view showing an example of the second hysteresis adjusting unit 54.

Referring to FIGS. 3A and 3B, each of the hysteresis adjusting units may include a plurality of switch elements connected to one another in parallel and resistor elements connected to respective switch elements in series. The hysteresis adjusting unit may output the hysteresis information based on the control signal of the controlling unit 40. For example, the hysteresis adjusting unit may output information for the upper limit and the lower limit of the hysteresis.

In the present embodiment, a case in which each of the hysteresis adjusting units 52 and 54 includes four switch elements and resistor elements connected to respective switch elements in series is illustrated; however, the present invention is not limited thereto. In addition, a case in which the control signal controlling the hysteresis adjusting units 52 and 54 is the hysteresis control bit described in Table 1 will be described.

Referring to FIG. 3A, the first hysteresis adjusting unit 52 may be formed of a plurality of switch elements S1, S2, S3, and S4 connected to one another in parallel, and resistor elements R1, R2, R3, and R4 connected to respective switch elements S1, S2, S3, and S4 in series.

Meanwhile, respective resistance values of the resistor elements may be different from each other. For example, R1 may be set to R(Ω), R2 may be set to 2R(Ω), R3 may be set to 3R(Ω), and R4 may be set to 4R(Ω). That is, the resistance value of R1 may be relatively lowest and the resistance value of the R4 may be relatively highest.

Referring to FIG. 3B, the second hysteresis adjusting unit 54 may be formed of a plurality of switch elements S5, S6, S7 and S8 connected to one another in parallel, and resistor elements R5, R6, R7, and R8 connected to respective switch elements S5, S6, S7 and S8 in series.

Meanwhile, respective resistance values of the resistor elements may be different from each other. For example, R5 may be set to R(Ω), R6 may be set to 2R(Ω), R7 may be set to 3R(Ω), and R8 may be set to 4R(Ω). That is, the resistance value of R5 may be relatively lowest and the resistance value of the R8 may be relatively highest.

Referring to Table 1, in the case in which the hysteresis control bit value is relatively lowest, it is confirmed that the input voltage has the relatively smallest range. Therefore, in the case in which the hysteresis control bit value is relatively low, the hysteresis range may be decreased. Therefore, in this case, the first hysteresis adjusting unit 52 and the second hysteresis adjusting unit 54 may have relatively high resistance values.

Therefore, the resistor element R4 having the relatively highest resistance value needs to be selected in the first hysteresis adjusting unit 52, and the resistor element R8 having the relatively highest resistance value may also be selected in the hysteresis adjusting unit 54.

Referring to FIGS. 3A and 3B, in the case in which the switch element S4 is the PMOS transistor and the switch element S8 includes the NMOS transistor, a low signal is applied to the switch element S4 and a high signal is applied to the switch element S8.

Meanwhile, a type of the switch elements S1 through S8 is not limited to thereto and various types of switch elements may be used.

In addition, referring to Table 1, in the case in which the hysteresis control bit value is highest, it is confirmed that the input voltage has the largest range. Therefore, in the case in which the hysteresis control bit value is relatively high, the hysteresis range may be widened. Therefore, in this case, the first hysteresis adjusting unit 52 and the second hysteresis adjusting unit 54 may have relatively low resistance values.

Therefore, the resistor element R1 having the lowest resistance value may be selected in the first hysteresis adjusting unit 52, and the resistor element R5 having the lowest resistance value may also be selected in the hysteresis adjusting unit 54.

Referring to FIGS. 3A and 3B, in the case in which the switch element S4 is the PMOS transistor and the switch element S8 includes the NMOS transistor, a low signal is applied to the switch element S1 and a high signal is applied to the switch element S5.

According to the same method, one resistor element R2 may be selected in the first hysteresis adjusting element 52, and one resistor element R6 may be selected in the second hysteresis adjusting unit 54. Alternatively, one resistor element R3 may be selected in the first hysteresis adjusting element 52, and one resistor element R7 may be selected in the second hysteresis adjusting unit 54.

According to the above-mentioned method, total resistance of the first hysteresis adjusting unit 52 and the second hysteresis adjusting unit 54 may be adjusted.

As the resistances of the first hysteresis adjusting unit 52 and the second hysteresis adjusting unit 54 are adjusted, the first hysteresis information Vop and the second hysteresis information Vrp may be adjusted.

For example, in the case in which the resistance of the first hysteresis adjusting unit 52 and the second hysteresis adjusting unit 54 is reduced, a difference between the first hysteresis information Vop (for example, the upper limit value of the hysteresis) and the second hysteresis information Vrp (for example, the lower limit value of the hysteresis) rises, whereby the hysteresis range may be increased.

In addition, in the case in which the resistance of the first hysteresis adjusting unit 52 and the second hysteresis adjusting unit 54 rises, the difference between the first hysteresis information Vop (for example, the upper limit value of the hysteresis) and the second hysteresis information Vrp (for example, the lower limit value of the hysteresis) may be reduced, whereby the hysteresis range may be relatively narrow.

In the case in which the reference voltage is increased, the hysteresis range may be increased. In addition, in the case in which the reference voltage is decreased, the hysteresis range may be decreased.

According to the embodiment of the present invention, in the case in which the reference voltage is increased, the hysteresis range may be increased by the controlling unit 40, the first hysteresis adjusting unit 52, and the second hysteresis adjusting unit 54.

In addition, in the case in which the reference voltage is decreased, the hysteresis range may be relatively narrow by the controlling unit 40, the first hysteresis adjusting unit 52, and the second hysteresis adjusting unit 54.

That is, referring to FIGS. 2 and 3 and Table 1, in the case in which the reference voltage corresponds to the level of the smallest range (No. 1), the resistances of the first hysteresis adjusting unit 52 and the second hysteresis adjusting unit 54 have the highest values according to the hysteresis control bit, correspondingly. Therefore, the hysteresis range may be relatively narrowest. In addition, in the case in which the reference voltage corresponds to the level of the largest range (No. 5), the resistances of the first hysteresis adjusting unit 52 and the second hysteresis adjusting unit 54 have relatively lowest values according to the hysteresis control bit, correspondingly. Therefore, the hysteresis range may be the widest.

Therefore, according to the embodiment of the present invention, the hysteresis range may be appropriately adjusted according to the reference voltage. In addition, according to the embodiment of the present invention, an output voltage supply device having improved noise immunity characteristics may be provided.

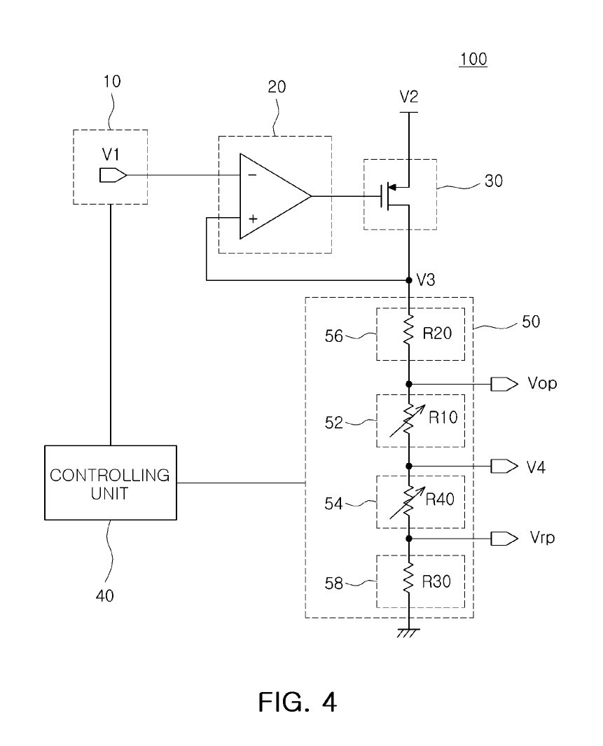

FIG. 4 is a view showing a voltage supply device according to another embodiment of the present invention.

Referring to FIG. 4, the outputting unit 50 may include a hysteresis adjusting unit and a voltage-dividing unit.

The hysteresis adjusting unit may include a first adjusting unit 52 and a second adjusting unit 54. The hysteresis adjusting unit may adjust the hysteresis information Vop and Vrp. In addition, the hysteresis adjusting unit may be formed by variable resistor elements R10 and R40.

The voltage-dividing unit may include a first voltage-dividing unit 56 and a second voltage-dividing unit 58. In addition, the voltage-dividing unit may be formed by resistor elements R20 and R30.

Referring to FIG. 4, the first voltage-dividing unit 56, the first adjusting unit 52, the second adjusting unit 54, and the second voltage-dividing unit 58 may be connected to one another in series in this sequence.

In this case, in the case in which the resistances of the first hysteresis adjusting unit 52 and the second hysteresis adjusting unit 54 rise, the difference between the first hysteresis information Vop (for example, the upper limit value of the hysteresis) and the second hysteresis information Vrp (for example, the lower limit value of the hysteresis) rises, whereby the hysteresis range may be increased.

Therefore, in the present embodiment, in the case in which the hysteresis range needs to be widened, the controlling unit and the hysteresis adjusting unit described in FIGS. 2 and 3 may be appropriately changed and used so that the resistance values of the first hysteresis adjusting unit 52 and the second hysteresis adjusting unit 54 rise.

In addition, in the case in which the resistances of the first hysteresis adjusting unit 52 and the second hysteresis adjusting unit 54 fall, the difference between the first hysteresis information Vop (for example, the upper limit value of the hysteresis) and the second hysteresis information Vrp (for example, the lower limit value of the hysteresis) may be reduced, whereby the hysteresis range may be decreased.

Therefore, in the present embodiment, in the case in which the hysteresis range needs to be reduced, the controlling unit and the hysteresis adjusting unit described in FIGS. 2 and 3 may be appropriately changed and used so that the resistance values of the first hysteresis adjusting unit 52 and the second hysteresis adjusting unit 54 fall.

Since the above described method may be equally applied to other configurations, detailed descriptions of the other configurations will be omitted.

The above described methods according to the embodiment of the present invention may be used separately from or in combination with each other. In addition, the operations configuring each of the embodiments may be used separately from or in combination with the operations configuring another embodiment.

In addition, the above described methods may be implemented in a recording medium readable by a computer or similar devices, using software, hardware or a combination thereof.

According to the hardware implementation, the above described methods may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electrical units for performing other functions.

According to the software implementation, procedures and functions described in the specification may be implemented in separate software modules. The software modules may be implemented by a software code which is written by a suitable program language. The software code may be stored in a storage unit and may be executed by a processor.

As set forth above, according to the embodiments of the present invention, a voltage supply device capable of outputting an output voltage varying at a predetermined ratio according to a change of reference voltage may be provided.

Further, according to the embodiments of the present invention, a voltage supply device capable of adjusting a hysteresis range of an output voltage according to a reference voltage may be provided.

While the present invention has been shown and described in connection with the embodiments, it will be apparent to those skilled in the art that modifications and variations can be made without departing from the spirit and scope of the invention as defined by the appended claims.

What is claimed is:

1. A voltage supply device, comprising:
an inputting unit obtaining a reference voltage;
an operational amplifier obtaining switching information based on the reference voltage and a feedback voltage;
a switching unit outputting an input voltage as the feedback voltage based on the switching information from the operational amplifier;
a controlling unit obtaining a control signal based on the reference voltage; and
an outputting unit outputting an output voltage and hysteresis information based on the control signal.

2. The voltage supply device of claim 1, wherein the controlling unit includes a plurality of comparators comparing the reference voltage with a reference value.

3. The voltage supply device of claim 1, wherein the controlling unit includes at least one of a peak detector and an analog to digital converter.

4. The voltage supply device of claim 1, wherein the control signal includes hysteresis control bits.

5. The voltage supply device of claim 1, wherein the outputting unit includes a first hysteresis adjusting unit, a first voltage-dividing unit, a second voltage-dividing unit, and a second hysteresis adjusting unit connected to one another in series.

6. The voltage supply device of claim 1, wherein the outputting unit includes a hysteresis adjusting unit adjusting a hysteresis range.

7. The voltage supply device of claim 6, wherein the hysteresis adjusting unit adjusts a resistance value based on the control signal.

8. The voltage supply device of claim 6, wherein the hysteresis adjusting unit includes at least one variable resistor element.

9. The voltage supply device of claim 6, wherein the hysteresis adjusting unit includes resistor elements and switch elements connected to one another in series, and controls the switch elements based on the control signal.

10. The voltage supply device of claim 2, wherein the operational amplifier is a rail to rail type amplifier.

11. A voltage supply device, comprising:
an inputting unit obtaining a reference voltage;
a controlling unit obtaining a control signal based on the reference voltage; and
an outputting unit obtaining output voltage and hysteresis information based on the control signal.

12. The voltage supply device of claim 11, wherein the controlling unit includes a plurality of comparators comparing the reference voltage with a reference value.

13. The voltage supply device of claim 11, wherein the controlling unit includes at least one of a peak detector and an analog to digital converter.

14. The voltage supply device of claim 11, wherein the control signal includes hysteresis control bits.

15. The voltage supply device of claim 11, wherein the outputting unit includes a hysteresis adjusting unit adjusting the hysteresis information.

16. The voltage supply device of claim 15, wherein the hysteresis adjusting unit adjusts a resistance value based on the control signal.

17. The voltage supply device of claim 15, wherein the hysteresis adjusting unit includes at least one variable resistor element.

18. The voltage supply device of claim 15, wherein the hysteresis adjusting unit includes resistor elements and switch elements connected to one another in series, and controls the switch elements based on the control signal.
